(19) United States
(12) Patent Application Publication
(10) Pub. No.: US 2023/0347935 A1
(43) Pub. Date: Nov. 2, 2023

(54) CONTROL METHOD OF AUTONOMOUS VEHICLE AND CONTROL SYSTEM

(71) Applicant: TOYOTA JIDOSHA KABUSHIKI KAISHA, Toyota-shi (JP)

(72) Inventors: Hiromitsu KOBAYASHI, Nisshin-shi (JP); Miki NOMOTO, Nisshin-shi (JP); Yoshiki UEDA, Susono-shi (JP); Taizo MASUDA, Yokohama-shi (JP); Yuta KATAOKA, Susono-shi (JP); Satoshi OMI, Ebina-shi (JP); Yuki NISHIKAWA, Susono-shi (JP)

(21) Appl. No.: 18/180,251

(22) Filed: Mar. 8, 2023

(30) Foreign Application Priority Data
May 2, 2022 (JP) 2022-076336

(51) Int. Cl. B60Q 1/50; B60W 60/00; B60W 40/06

(52) U.S. Cl. CPC B60W 60/0016; B60Q 1/545; B60W 40/06; B60W 2555/20

(57) ABSTRACT

Flood damage information at the position of the autonomous vehicle and a flood index representing the likelihood of flooding at the position of the automatically driving vehicle are acquired. Based on the flood damage information and the flood index, a predicted flood water level at the position of the autonomous vehicle is obtained. A predicted flood water level is displayed in the form of a height position from the road surface on a display mounted on the autonomous vehicle so that it can be visually recognized from the outside of the autonomous vehicle.

### CROSS-REFERENCE TO RELATED APPLICATION

This application claims priority to Japanese Patent Application No. 2022-076336 filed on May 2, 2022, incorporated herein by reference in its entirety.

### BACKGROUND

### 1. Technical Field

The present disclosure relates to a control method of an autonomous vehicle and a control system.

### 2. Description of Related Art

An alarm system is known in which a pole-shaped cordless extension unit having a water level sensor and a light emitting unit is installed on the ground, and in which the flood water level detected by the water level sensor is indicated by a light emitting pattern of a light emitting unit (for example, refer to Japanese Unexamined Patent Application Publication No. 2018-124602 (JP 2018-124602 A)). In JP 2018-124602 A, the flood water level detected by the water level sensor is also displayed on the display of a car navigation system of the vehicle.

### SUMMARY

However, there is a possibility that the light emission pattern of the light-emitting unit cannot clearly convey the height up to which the flood water level corresponds with respect to a pedestrian and a building, that is, the height up to which the pedestrian sinks in the water. Display on the display in the vehicle is the same. In other words, the pedestrian and the like may not be able to accurately grasp the danger of flood damage.

According to the present disclosure, the following are provided.

### Configuration 1

A control method of an autonomous vehicle, the method comprising:
acquiring flood damage information at a position of the autonomous vehicle and a flood index representing a likelihood of flooding at the position of the autonomous vehicle;
acquiring a flood water level prediction value at the position of the autonomous vehicle based on the flood damage information and the flood index; and
displaying the flood water level prediction value in a manner of a height position from a road surface, on a display mounted on the autonomous vehicle such that the flood water level prediction value is able to be visually recognized from an outside of the autonomous vehicle.

### Configuration 2

The control method according to configuration 1, in which the flood index is terrain information at the position of the autonomous vehicle.

### Configuration 3

The control method according to configuration 2, further including acquiring the terrain information by using a terrain sensor that is mounted on the autonomous vehicle and that is configured to detect the terrain information.

### Configuration 4

The control method according to any one of configurations 1 to 3, further including moving the autonomous vehicle by autonomous driving to a safe area when the control method determines that the flood water level prediction value is greater than a predetermined threshold value.

### Configuration 5

The control method according to configuration 4, in which moving the autonomous vehicle to the safe area is executed when the flood water level prediction value is greater than the threshold value and an occupant is present in the autonomous vehicle.

### Configuration 6

A control system of an autonomous vehicle, the control system including:
a display mounted on the autonomous vehicle so as to be able to be visually recognized from an outside the autonomous vehicle;
an information acquisition unit configured to acquire flood damage information at a position of the autonomous vehicle and a flood index representing a likelihood of flooding at the position of the autonomous vehicle;
a prediction unit configured to acquire a flood water level prediction value at the position of the autonomous vehicle based on the flood damage information and the flood index; and
a display control unit configured to display the flood water level prediction value on the display in a manner of a height position from a road surface. Configuration 7 The control system according to configuration 6, in which the flood index is terrain information at the position of the autonomous vehicle. Configuration 8
The control system according to configuration 7 further including a terrain sensor that is mounted on the autonomous vehicle and that is configured to detect the terrain information, in which the information acquisition unit is configured to acquire the terrain information by using the terrain sensor.

### Configuration 9

The control system according to any one of configurations 6 to 8, further including an autonomous driving control unit configured to move the autonomous vehicle by autonomous driving to a safe area when the control system determines that the flood water level prediction value is greater than a predetermined threshold value.

### Configuration 10

The control system according to configuration 9, in which the autonomous driving control unit is configured to move the autonomous vehicle to a safe area when the control system determines that the flood water level prediction value is greater than the threshold value and that an occupant is present in the autonomous driving vehicle.

A pedestrian and the like can be accurately informed of the danger of flood damage.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram of an example autonomous vehicle control system according to the present disclosure;

FIG. 2 is a schematic diagram of an example autonomous vehicle according to the present disclosure;

FIG. 3 is a schematic diagram of an example server according to the present disclosure;

FIG. 4 is a diagram showing a display example on a display of an embodiment according to the present disclosure;

FIG. 5 is a flowchart illustrating an example autonomous vehicle control routine according to the present disclosure;

FIG. 6 is a functional block diagram of a processor of an example autonomous vehicle according to the present disclosure;

FIG. 7 is a flowchart illustrating another example autonomous vehicle control routine in accordance with the present disclosure; and

FIG. 8 is a functional block diagram of a processor of another example autonomous vehicle according to the present disclosure.

### DETAILED DESCRIPTION OF EMBODIMENTS

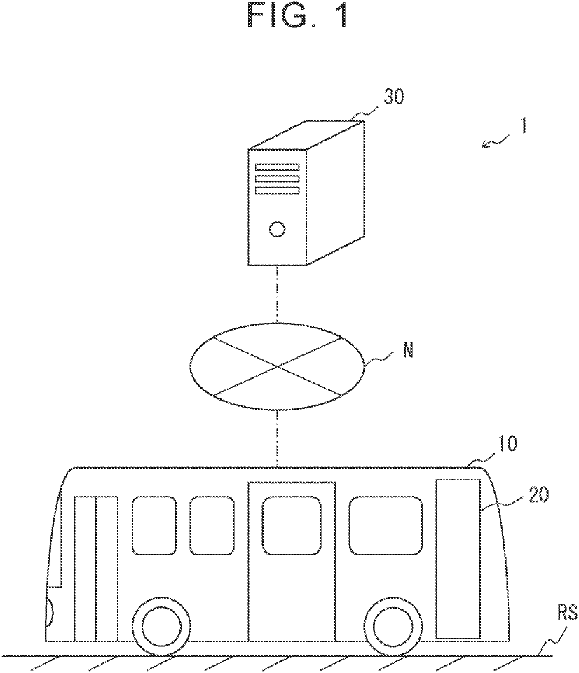

FIG. 1 schematically illustrates an example autonomous vehicle control system 1 according to the present disclosure. Referring to FIG. 1, an example control system 1 according to the present disclosure comprises an autonomous vehicle 10 and a server 30 that can communicate with each other via a communication network N, such as the Internet. In the example shown in FIG. 1, the autonomous vehicle 10 is composed of vehicles such as buses and taxis that run on the road surface RS.

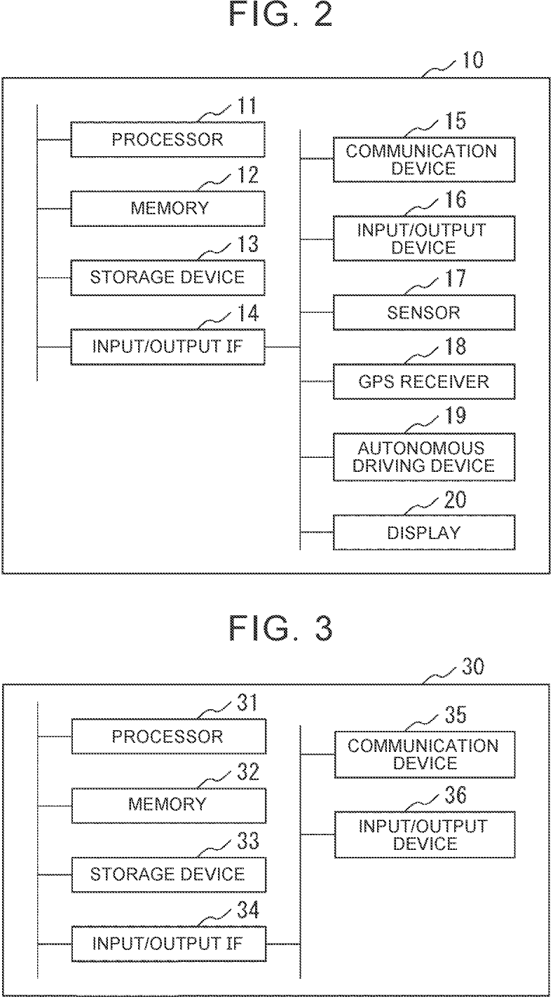

An example autonomous vehicle 10 according to the present disclosure, as shown schematically in FIG. 2 are one or more processors 11, one or more memories 12, a storage device 13, and an input/output interface (IF) 14 communicatively connected to each other by a bi-directional bus.

Memory 12 in embodiments according to the present disclosure includes volatile or non-volatile memory. Various programs are stored in the memory 12, and these programs are executed by the processor 11. The storage device 13 of the embodiment according to the present disclosure stores a calculation model, a travel route of the autonomous vehicle 10, and the like.

A communication device 15, an input/output device 16, one or more sensors 17, a GPS receiver 18, an autonomous driving device 19, and a display 20 are communicatively connected to the input/output IF 14 of the embodiment according to the present disclosure. A communication device 15 in an embodiment according to the present disclosure is communicatively connected to the communication network N described above. Example input/output devices 16 in accordance with the present disclosure include, for example, keyboards, mice, media reader/writers, in-vehicle displays, and the like. The sensor 17 of the embodiment according to the present disclosure includes a camera for automatic driving, LiDAR, etc., as well as terrain information (for example, sea level, height difference with the surroundings, etc.) at the position of the autonomous vehicle 10. A terrain sensor is included. In one example, the terrain sensor includes LiDAR. GPS receiver 18 in embodiments according to this disclosure receives signals from GPS satellites and thereby detects information representing the absolute position (e.g., longitude and latitude) of autonomous vehicle 10. The example autonomous driving device 19 of the present disclosure includes actuators that respectively drive, steer, and brake the autonomous vehicle 10.

An example display 20 according to the present disclosure is mounted on the autonomous vehicle 10 so as to be visible from outside the autonomous vehicle 10. In the example shown in FIG. 1, the display 20 is mounted outside the side of the autonomous vehicle 10. Also, the lower edge of the display 20 is positioned near the road surface RS. In the example shown in FIG. 1, the bottom edge of display 20 is positioned around the bottom edge of the body of autonomous vehicle 10.

An example server 30 according to the present disclosure, as shown schematically in FIG. 3, comprises one or more processors 31, one or more memories 32, storage devices 33, and an input/output interface (IF) 34, both of which communicatively connected to each other by a directional bus.

Memory 32 in embodiments according to the present disclosure includes volatile or non-volatile memory. Various programs are stored in the memory 32, and these programs are executed by the processor 31. The storage device 33 of the embodiment according to the present disclosure stores a flood index (described later) and the like.

A communication device 35 and an input/output device 36 are communicably connected to the input/output IF 34 of the embodiment according to the present disclosure. A communication device 35 in an embodiment according to the present disclosure is communicatively connected to the communication network N described above. Example input/output devices 36 in accordance with the present disclosure include, for example, keyboards, mice, media reader/writers, in-vehicle displays, and the like.

Now, in embodiments according to the present disclosure, the autonomous vehicle 10 detects the position of the autonomous vehicle 10 as described above. The position of the autonomous vehicle 10 is sent from the autonomous vehicle 10 to the server 30. Meanwhile, the server 30 receives flood damage information at various locations, for example, from a weather forecasting agency. This flood information includes rainfall forecast values at various locations, particularly rainfall forecast values greater than a predetermined threshold. The server 30 transmits this flood information to the autonomous vehicle 10, when the flood information at the position of the autonomous vehicle 10 is included in the received flood information.

Upon receiving the flood damage information, the autonomous vehicle 10 acquires a flood index representing the likelihood of flooding at the position of the autonomous vehicle 10. In one example, the flood index is terrain information at the location of the autonomous vehicle 10 detected by a terrain sensor. In another example, the flood information is a hazard map representing the extent of flooding at various locations. The hazard map is pre-stored in the storage device 13 of the autonomous vehicle 10 in one example. In another example, the hazard map is pre-stored in the storage device 33 of the server 30 and transmitted from the server 30 to the autonomous vehicle 10. Hazard maps are provided in advance by local governments and others.

The autonomous vehicle 10 then obtains a predicted flood water level at the position of the autonomous vehicle 10 based on the flood damage information and the flood index.

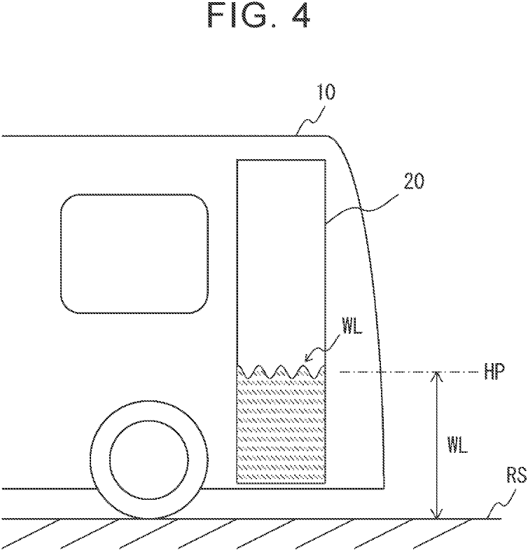

When the predicted flood water level is obtained, the autonomous vehicle 10 displays the predicted flood water level on the display 20. In this case, the predicted flood water level WL is displayed on the display 20 in the form of a height position from the road surface RS, as shown in FIG. 4. In the example shown in FIG. 4, a wavy line is drawn at a position HP higher than the road surface RS by the predicted flood water level WL, and an image is drawn in which a portion lower than the wavy line is submerged in water. In this way, pedestrians on the road surface RS can easily grasp how much flooding will occur. That is, it becomes possible for pedestrians and the like to accurately grasp the risk of flood damage. As a result, pedestrians and the like are urged to quickly evacuate. In addition, since the flood water level predicted value is displayed on the display 20 of the moving autonomous vehicle 10, the risk of flood damage is notified at various positions.

In another example, the predicted flood water level is additionally displayed on the display 20 in the form of textual information (e.g., “1.2 meters”). In yet another example, information such as an example of a disaster predicted at the current position of the autonomous vehicle 10 when flooding of the predicted flood water level occurs, and an evacuation route from the current position of the autonomous vehicle 10 is displayed. 20 additionally displayed. In yet another example, flood water levels during past floods are additionally or alternatively displayed at the current position of the autonomous vehicle 10.

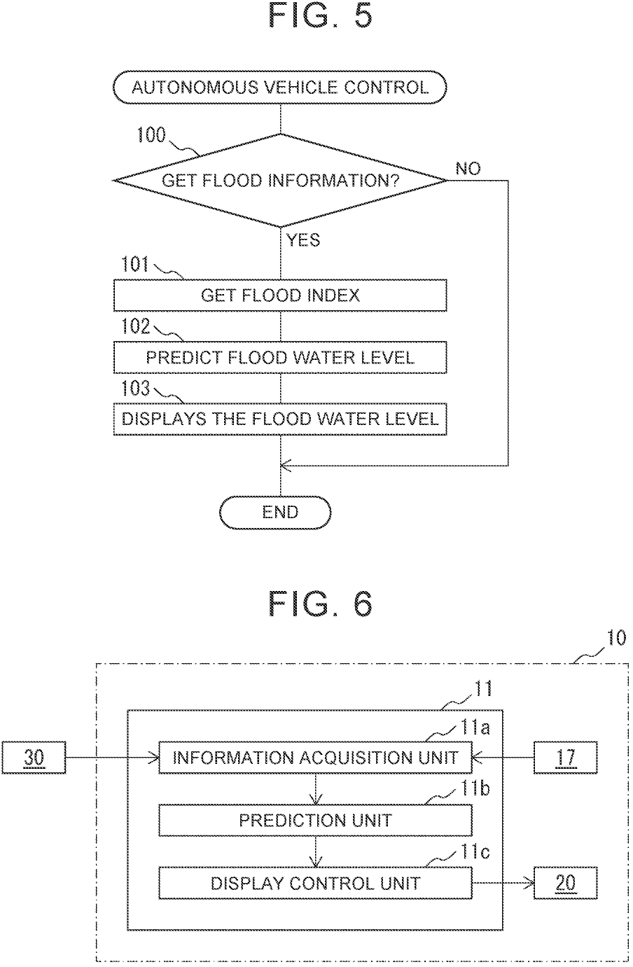

FIG. 5 shows an automatic driving control routine in an embodiment according to the present disclosure. This routine is executed by the processor 11 of the autonomous vehicle 10. Referring to FIG. 5, at step 100, it is determined whether flood information at the location of the autonomous vehicle 10 has been received. When the flood information is not received, the processing cycle is terminated. When flood damage information is received, the process then proceeds to step 101 to acquire a flood index. In the subsequent step 102, the flood water level is predicted. In step 103 that follows, the flood water level is displayed on the display 20.

In another example, server 30 transmits flood information at various locations to autonomous vehicle 10. If the received flood damage information includes flood damage information at the position of the autonomous vehicle 10, the autonomous vehicle 10 acquires a flood index and obtains a predicted flood water level.

FIG. 6 is a functional block diagram of the processor 11 of the autonomous vehicle 10 in an embodiment according to this disclosure. Referring to FIG. 6, the processor 11 includes an information acquisition unit 11a configured to acquire flood damage information at the position of the autonomous vehicle 10 and a flood index representing the likelihood of flooding at the position of the autonomous vehicle 10. and a prediction unit 11b configured to obtain a predicted flood water level at the position of the autonomous vehicle 10 based on the flood damage information and the flood index; and a display control unit 11c configured to display on the display 20. In the example shown in FIG. 6, the information acquisition unit 11a acquires flood information from the server 30 and acquires the flood index from the sensor 17.

Another embodiment according to the present disclosure will now be described. To explain the difference from the above-described embodiment according to the present disclosure, in another embodiment according to the present disclosure, the flood water level prediction value at the position of the autonomous vehicle 10 is greater than a predetermined threshold, and the automatic When it is determined that an occupant is present in the autonomous vehicle 10, the autonomous vehicle 10 moves to a safe area by automatic driving. In other words, the autonomous vehicle 10 changes its prescribed driving route and heads for the safe area. On the other hand, when it is determined that the predicted flood water level at the position of the autonomous vehicle 10 is smaller than the threshold value, or when it is determined that there is no occupant in the autonomous vehicle 10, the automatic driving The vehicle 10 continues traveling along the specified travel route.

Another example threshold according to the present disclosure is, in one example, an upper water level at which safe operation of the autonomous vehicle 10 is ensured. In another example, the threshold is the upper water level above which safe movement of passengers or pedestrians is ensured. In yet another example, the threshold is the lesser of these high water levels. As a result, safe movement of the autonomous vehicle 10 or the occupants is ensured.

On the other hand, the safe area of another example according to the present disclosure is, in one example, an area where the flood water level is estimated to be lower than at the current location of the autonomous vehicle 10. Examples of such safe areas include areas where the altitude above sea level is greater than the current location of the autonomous vehicle 10. For example, when the autonomous vehicle 10 is traveling downhill, the autonomous vehicle 10 is moved to a safe area by backing up. In another example, a safe area is an area of lower flood water level defined by a hazard map.

In another example, regardless of whether there is an occupant in the autonomous vehicle 10, the autonomous vehicle 10 enters the safe area when the predicted flood water level at the position of the autonomous vehicle 10 is greater than a threshold value. move up to

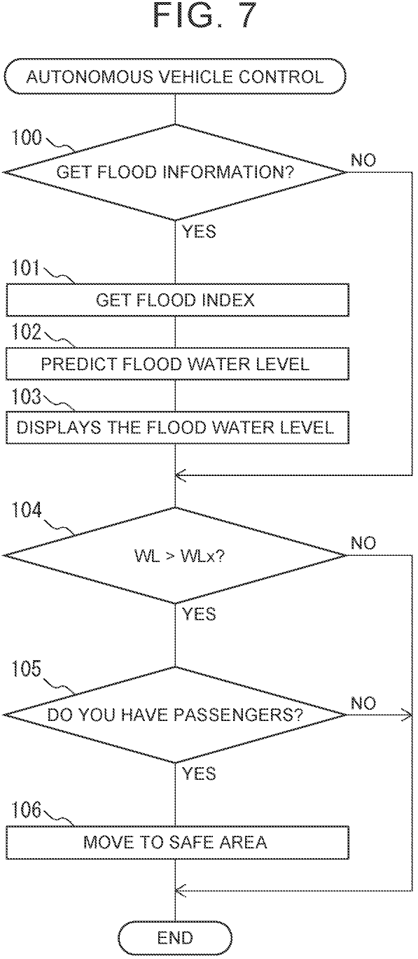

FIG. 7 shows an automatic driving control routine in another embodiment according to the present disclosure. This routine is executed by the processor 11 of the autonomous vehicle 10. 5. In the routine of FIG. 7, step 103 is followed by step 104, where it is determined whether the predicted flood water level WL is greater than the threshold value WLx. When WL>WLx, the process then proceeds to step 105, where it is determined whether or not a passenger is present in the autonomous vehicle 10. When it is determined that an occupant is present in the autonomous vehicle 10, the process then proceeds to step 106, where the autonomous vehicle 10 is moved to a safe area by automatic operation. On the other hand, when WL≤WLx in step 104, or when there is no occupant in the autonomous vehicle 10 in step 105, the processing cycle ends.

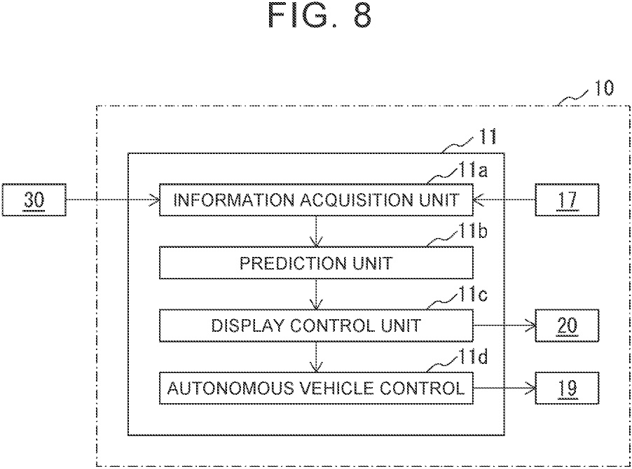

FIG. 8 is a functional block diagram of processor 11 of another example autonomous vehicle 10 according to the present disclosure. The difference from the functional block diagram of FIG. 6 will be explained. In the functional block diagram of FIG. 8 the processor 11 further includes an automatic operation control unit 11d configured to move the autonomous vehicle 10 by automatic operation.

In another example, the server 30 executes at least one of acquires flood damage information at the position of the autonomous vehicle and a flood index representing the likelihood of flooding at the position of the autonomous vehicle, and based on the flood information and the flood index, obtaining the predicted flood water level at the position of the autonomous driving vehicle, and displaying the predicted flood water level in the form of the height position from the road surface on the display mounted on the autonomous driving vehicle so that it can be visually recognized from the outside of the autonomous driving vehicle, and automatically moving the automatically operated vehicle to a safe area when it is determined that the predicted flood water level is greater than a predetermined threshold value.

What is claimed is:

1. A control method of an autonomous vehicle, the control method comprising:
acquiring flood damage information at a position of the autonomous vehicle and a flood index representing a likelihood of flooding at the position of the autonomous vehicle;
acquiring a flood water level prediction value at the position of the autonomous vehicle based on the flood damage information and the flood index; and
displaying the flood water level prediction value in a manner of a height position from a road surface, on a display mounted on the autonomous vehicle such that the flood water level prediction value is able to be visually recognized from an outside of the autonomous vehicle.

2. The control method according to claim 1, wherein the flood index is terrain information at the position of the autonomous vehicle.

3. The control method according to claim 2, further comprising acquiring the terrain information by using a terrain sensor that is mounted on the autonomous vehicle and that is configured to detect the terrain information.

4. The control method according to claim 1, further comprising moving the autonomous vehicle by autonomous driving to a safe area when the control method determines that the flood water level prediction value is greater than a predetermined threshold value.

5. The control method according to claim 4, wherein moving the autonomous vehicle to the safe area is executed when the flood water level prediction value is greater than the threshold value and an occupant is present in the autonomous vehicle.

6. A control system of an autonomous vehicle, the control system comprising:
a display mounted on the autonomous vehicle so as to be able to be visually recognized from an outside the autonomous vehicle;
an information acquisition unit configured to acquire flood damage information at a position of the autonomous vehicle and a flood index representing a likelihood of flooding at the position of the autonomous vehicle;
a prediction unit configured to acquire a flood water level prediction value at the position of the autonomous vehicle based on the flood damage information and the flood index; and
a display control unit configured to display the flood water level prediction value on the display in a manner of a height position from a road surface.

7. The control system according to claim 6, wherein the flood index is terrain information at the position of the autonomous vehicle.

8. The control system according to claim 7, further comprising a terrain sensor that is mounted on the autonomous vehicle and that is configured to detect the terrain information, wherein the information acquisition unit is configured to acquire the terrain information by using the terrain sensor.

9. The control system according to claim 6, further comprising an autonomous driving control unit configured to move the autonomous vehicle by autonomous driving to a safe area when the control system determines that the flood water level prediction value is greater than a predetermined threshold value.

10. The control system according to claim 9, wherein the autonomous driving control unit is configured to move the autonomous vehicle to the safe area when the control system determines that the flood water level prediction value is greater than the threshold value and that an occupant is present in the autonomous vehicle.
